(19) United States
(12) Patent Application Publication
(10) Pub. No.: US 2022/0198963 A1
(43) Pub. Date: Jun. 23, 2022

(54) INFORMATION DISPLAY

(71) Applicant: Joe D. Guerriero, Montgomery, TX (US)

(72) Inventor: Joseph D. Cascio, Monroe, LA (US)

(73) Assignee: Joe D. Guerriero, Montgomery, TX (US)

(21) Appl. No.: 17/130,786

(22) Filed: Dec. 22, 2020

(51) Int. Cl. G09F 7/20

(52) U.S. Cl. CPC G09F 7/20; G09F 2007/1817

(57) ABSTRACT

The present disclosure provides a system for displaying information comprising a box having first and second faces and edges defining an internal container. The first and second faces are adapted to display information. Either of the first or second faces has a panel that is adapted to provide access to the internal container. In another embodiment, the system further comprises a holder adapted to receive a sign. In another embodiment, the system further comprises a support adapted to mount the system on a post. In another embodiment, the system further comprises a sign mounted on a holder adapted to receive the sign. In another embodiment, the system further comprises a holder mounted on one or more of the edges. In another embodiment, the internal container is adapted to receive one or more signs. In another embodiment, the panel is adapted to fasten to an edge. In another embodiment, the first and second faces contain printed indicia that display information. In another embodiment, the panel is hinged to either the first or second face.

### FIELD OF THE DISCLOSURE

The present disclosure relates generally to provision of information and, more particularly, to systems and methods for displaying information.

### BACKGROUND

It is customary to sell residential real estate using yard signs. Typically, the yard sign includes advertising promoting the real estate agent responsible for the listing. Such an advertisement might include the name and contact information together with a picture or some other image. It is also customary to attach smaller signs to the yard sign indicating such things as a “New Listing,” “Open House,” or “Sold.” A problem arises with respect to attaching these smaller signs to the yard sign. Typically, the smaller signs are stored at a location distant from the location of the yard sign. This requires someone, usually the agent, to retrieve the smaller sign and travel to the location of the yard sign and attach the smaller sign to the yard sign. This is time consuming and diverts the agents attention from his or her core activity—selling homes. Thus, a heretofore unaddressed need exists in the industry to address the aforementioned deficiencies and inadequacies.

### SUMMARY

The present disclosure provides a system for displaying information comprising a box having first and second faces and edges defining an internal container. The first and second faces are adapted to display information. Either of the first or second faces has a panel that is adapted to provide access to the internal container. In another embodiment, the system further comprises a holder adapted to receive a sign. In another embodiment, the system further comprises a support adapted to mount the system on a post. In another embodiment, the system further comprises a sign mounted on a holder adapted to receive the sign. In another embodiment, the system further comprises a holder mounted on one or more of the edges. In another embodiment, the internal container is adapted to receive one or more signs. In another embodiment, the panel is adapted to fasten to an edge. In another embodiment, the first and second faces contain printed indicia that display information. In another embodiment, the panel is hinged to either the first or second face.

In another embodiment, a system for displaying information comprises a first face adapted to display information, a second face adapted to display information and a plurality of edges. The first and second faces together with the edges define an internal cavity suitable for storing one or more signs. One of the first or second faces has a panel for providing access to the internal cavity. In another embodiment, the signs are adapted to display information. In another embodiment, at least one of the edges is adapted to receive at least one sign. In another embodiment, the panel is adapted to fasten to one of the edges.

In another embodiment, a system for displaying information comprises a first face adapted to display information and a second face adapted to display information. The second face has a moveable panel. The system has four edges with at least one edge adapted to receive one or more signs. The first and second faces together with the four edges define a box having an internal cavity. The internal cavity is accessible by way of the panel and adapted to hold one or more signs. In another embodiment, the signs are adapted to display information. In another embodiment, the signs and at least one edge have complimentary holders. In another embodiment, the panel has a first fastener and an edge has a complimentary fastener. In another embodiment, at least one edge has a mount for fixing the information display to a stand. In another embodiment, the panel is adapted to fasten to at least one edge. In another embodiment, at least one of the first and second faces have indicia for conveying information.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of the information display of the present invention;

FIG. 2 is a perspective view of the information display of FIG. 1 with an open panel; and

FIG. 3 is a cross-section view of the information display of FIG. 1 along the line 3-3.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

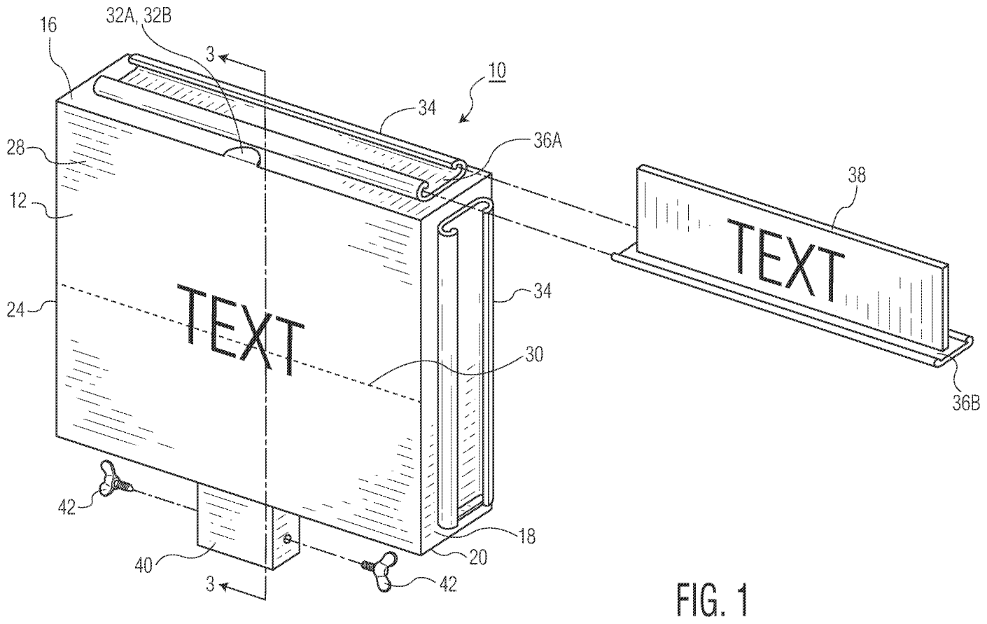

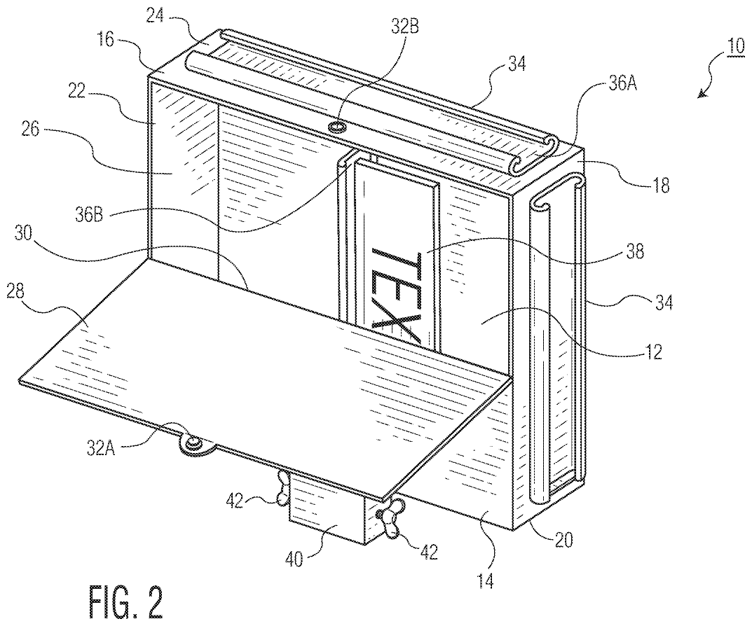

Referring now to FIG. 1, a perspective view of the information display of the present invention, a system for displaying information 10 is shown. The information displayed is shown generically as TEXT but should be understood to be any form of information or indicia including written text, images, photos, etc. System 10 has a first face 12, a second face 14, shown from the rear in FIG. 2, and four edges, 16, 18, 20 and 22 (FIG. 2). Faces 12 and 14 together with edges 16, 18, 20 and 22, together form box 24 defining an internal container or cavity 26 (FIG. 2). Second face 14 includes movable panel 28 that is connected to second face 14 at hinge 30. Moveable panel 28 provides access to cavity 26. Panel 28 may include complimentary fastener 32A that is adapted to mate to complimentary fastener 32B on edge 16. Complimentary fasteners 32 A and 32B can be snaps, hook and loop or any other fastener as is well known to those skilled in the art. One or more of edges 16, 18 and 22 maybe adapted to receive holder 34. In the preferred embodiment, at least one holder is attached to edge 16. Holder 34 has complimentary glide 36A adapted to receive sign 38 supported by complimentary glide 36B. Edge 20 is adapted to receive mount or support 40. Cavity 26 is adapted to receive one or more signs 38. In one embodiment, mount 40 is adapted to fit over a post (not shown) and is held in place by wing nuts 42. Faces 12 and 14 and sign 38 are adapted to receive and display information such as printed indicia. An example of printed indicia may be advertising such as the typical type of adverting use to promote real estate sales though the invention is not limited to real estate advertising.

Referring now to FIG. 2, a perspective view of the information display of FIG. 1 with an open panel, a system for displaying information 10 is shown with a sign 38 residing within cavity 26. Cavity 26 is defined by faces 12 and 14 and edges 16, 18, 20 and 22. One of faces 12 or 14 is has a panel 28 and hinge 30 to provide access to cavity 26. Panel 28 has fastener 32A that is complimentary to fastener 32B fixed to edge 16.

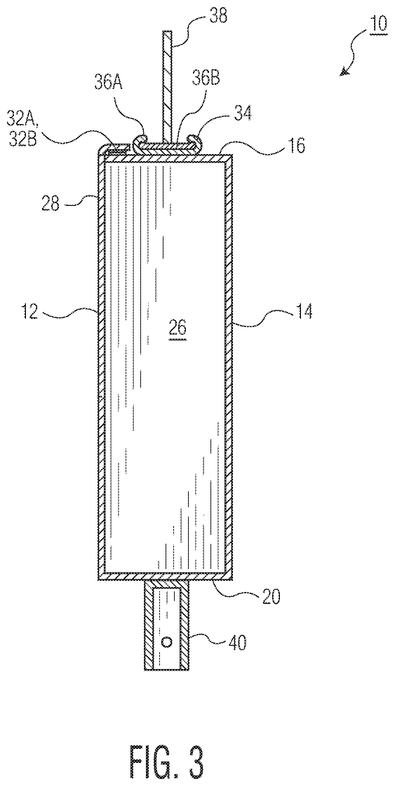

Referring now to FIG. 3, a cross-section view of the information display of FIG. 1 along the line 3-3, a system for displaying information 10 is shown with cavity 26 and sign 38 mounted on edge 16. Faces 12 and 14 together with edges 16, 18, 20 and 22 define cavity 26. Edge 16 is shown with holder 34 fixed to edge 16. Holder 34 includes glide 36A that is complimentary to glide 36B fixed to sign 38. Mount 40 is shown fixed to edge 20.

Although exemplary embodiments have been shown and described, it will be clear to those of ordinary skill in the art that a number of changes, modifications, or alterations to the disclosure as described may be made. For example, etc. All such changes, modifications, and alterations should therefore be seen as within the scope of the disclosure.

What is claimed is:

1. A system for displaying information comprising:
A box having first and second faces and edges defining an internal container;
The first and second faces adapted to display information; and
Either of the first or second faces having a panel that is adapted to provide access to the internal container.

2. The system of claim 1, further comprising a holder adapted to receive a sign.

3. The system of claim 1, further comprising a support adapted to mount the system on a post.

4. The system of claim 1, further comprising a sign mounted on a holder adapted to receive the sign.

5. The system of claim 1, further comprising a holder mounted on one or more of the edges.

6. The system of claim 1, wherein the internal container is adapted to receive one or more signs.

7. The system of claim 1, wherein the panel is adapted to fasten to an edge.

8. The system of claim 1, wherein the first and second faces contain printed indicia that display information.

9. The system of claim 1, wherein the panel is hinged to either the first or second face.

10. A system for displaying information comprising:
A first face adapted to display information;
A second face adapted to display information;
A plurality of edges;
The first and second faces together with the edges defining an internal cavity suitable for storing one or more signs; and
One of the first or second faces having a panel for providing access to the internal cavity.

11. The system of claim 10, wherein the signs are adapted to display information.

12. The system of claim 10, wherein at least one of the edges is adapted to receive at least one sign.

13. The system of claim 10, wherein the panel is adapted to fasten to one of the edges.

14. A system for displaying information comprising:
A first face adapted to display information;
A second face adapted to display information and having a moveable panel;
Four edges with at least one edge adapted to receive one or more signs;
The first and second faces together with the four edges defining a box having an internal cavity; and
The internal cavity accessible by way of the panel and adapted to hold one or more signs.

15. The system of claim 14, wherein the signs are adapted to display information.

16. The system of claim 14, wherein the signs and at least one edge have complimentary holders.

17. The system of claim 14, wherein the panel has a first fastener and an edge has a complimentary fastener.

18. The system of claim 14, wherein at least one edge has mount for fixing the information display to a stand.

19. The system of claim 14, wherein the panel is adapted to fasten to at least one edge.

20. The system of claim 14, wherein at least one of the first and second faces have indicia for conveying information.
